(19) United States
(12) Patent Application Publication
(10) Pub. No.: US 2002/0082067 A1
(43) Pub. Date: Jun. 27, 2002

(54) Computer game producing an award certificate and a contest mode of play

(76) Inventors: Michael J. Mckay, San Diego, CA (US); Joe L. Wilkins, Escondido, CA (US)

Correspondence Address: THE MATTHEWS FIRM, Suite 1800, 1900 West Loop South, Houston, TX, 77027, US

(21) Appl. No.: 09/995,482

(22) Filed: Nov. 28, 2001

Related U.S. Application Data
(63) Continuation of application No. 09/348,552, filed on Jul. 7, 1999, now abandoned.

(51) Int. Cl. A63F 13/00

(52) U.S. Cl. 463/9

(57) ABSTRACT

An electronic board game tests the players' knowledge of certain subject matter, such as religion. The players move their game pieces along a path and answer multipe-choice questions each turn, heading for a finish line. Points are awarded based on the speed with which the players answer the questions, the difficulty level of the questions, the player's age, or a combination of these. At the end of the game, an award certificate can be generated for the winner. The certificate can be used to enter a contest sponsored by an organization, with the ultimate winner being awarded a prize.

### RELATED APPLICATION

This is a Continuation of U.S. patent application Ser. No. 09/348,552, filed Jul. 7, 1999.

### FIELD OF THE INVENTION

The present invention is directed to a computerized game for one or more players which produces a certificate as a reward to the winner and offers a special contest mode of play.

### BACKGROUND OF THE INVENTION

Games come in a variety of packages, from outdoor games to board games. Board games have seen their latest incarnation in the form of computerized or electronic board games. Instead of physically moving game pieces over a decorated piece of cardboard or the like as is done in typical board games, computerized board games allow the players to move virtual game pieces over a virtual board, all of which appear on a television screen or other display.

Regardless of their type, the goal of most games is to win. But aside from his or her own temporary celebration of victory, the winner must settle for the accolades, if any, coming from the other players whom he or she has just defeated.

### BRIEF SUMMARY OF THE INVENTION

The present inventors have found that a need exists for a computerized game which produces an award to be given to and cherished by the winner. Accordingly, it is an object of the present invention to print an award certificate upon completion of a game, the certificate bearing official insignia and the information about the winner.

A broader object of the present invention is to provide a computerized game which automatically produces an award for the winner.

It is another object of the present invention to provide a computerized game which tests the player's knowledge of religion, and to award the winner with an attractive certificate.

It is yet another object of the present invention to provide a computerized game having a special contest mode in which players are pitted against one another in a plurality of games, the winner of each game is provided with an award certificate, and the certificates are collected to determine an ultimate winner.

Particular embodiments can be effective in developing a playful, computer-based, extracurricular competition for students in religious schools and parish religious education programs at appropriate grade levels; encouraging the active participation of students in learning a specified amount of religious information at home or as an extracurricular activity; promoting knowledge of religious vocabulary and basic teachings which are in conformity with a particular church or belief; and rewarding students who demonstrate interest and excellence in religious learning.

These and other objects are achieved by providing an electronic game having at least one mode of play, the one mode comprising inputting names of at least one player of the game; posing at least one of a plurality of questions to each player of the game during the player's respective turn; inputting, by the player, an answer to the question; accumulating a score for each player based upon whether answers to the questions are correct; selecting a winner based upon each player's score at the end of the game; and generating a certificate data packet, the data packet being a set of information for use by a printer to print a certificate, the data packet including the name of the winner.

These and other objects are also achieved by providing a recording medium bearing a computer-executable game, the game having at least one mode of play, the mode comprising inputting names of at least one player of the game; posing at least one of a plurality of questions to each player of the game during the player's respective turn; inputting, by the player, an answer to the question; accumulating a score for each player based upon whether answers to the questions are correct; selecting a winner based upon each player's score at the end of the game; and generating a certificate data packet, the data packet being a set of information for use by a printer to print a certificate, the data packet including the name of the winner.

Additional objects of the present invention are achieved by providing an electronic signal constituting a game, the game having at least one mode of play, the one mode comprising inputting names of at least one player of the game; posing at least one of a plurality of questions to each player of the game during the player's respective turn; inputting, by the player, an answer to the question; accumulating a score for each player based upon whether answers to the questions are correct; selecting a winner based upon each player's score at the end of the game; and generating a certificate data packet, the data packet being a set of information for use by a printer to print a certificate, the data packet including the name of the winner.

Further scope of applicability of the present invention will become apparent from a review of the detailed description and accompanying drawings. It should be understood that the description and examples, while indicating preferred embodiments of the present invention, are not intended to limit the breadth of the invention since various changes and modifications within the spirit and scope of the invention will become apparent to those skilled in the art.

### BRIEF DESCRIPTION OF THE DRAWINGS

The present invention will become more fully understood from the detailed description given below, together with the accompanying drawings which are given by way of illustration only, and thus are not to be construed as limiting the scope of the present invention. In the drawings:

FIG. 1 shows a virtual game board that can be used with preferred embodiments of the present invention.

FIG. 2 shows a graphic superimposed on the virtual game board of FIG. 1.

FIG. 3 shows a graphic that is displayed to game players in an embodiment of the present invention.

FIG. 4 shows a sample certificate that can be generated according to an embodiment of the present invention.

### DETAILED DESCRIPTION OF THE PREFERRED EMBODIMENTS

The following description of the preferred embodiments refers to a computerized game, but it should be understood that the present invention is applicable to any electronic game regardless whether it is played on a dedicated stand-alone game device, on a personal computer, or in a computer intranet or internet or other network environment. Most preferably, the device on which the game is played is connected to or integrated with a printer.

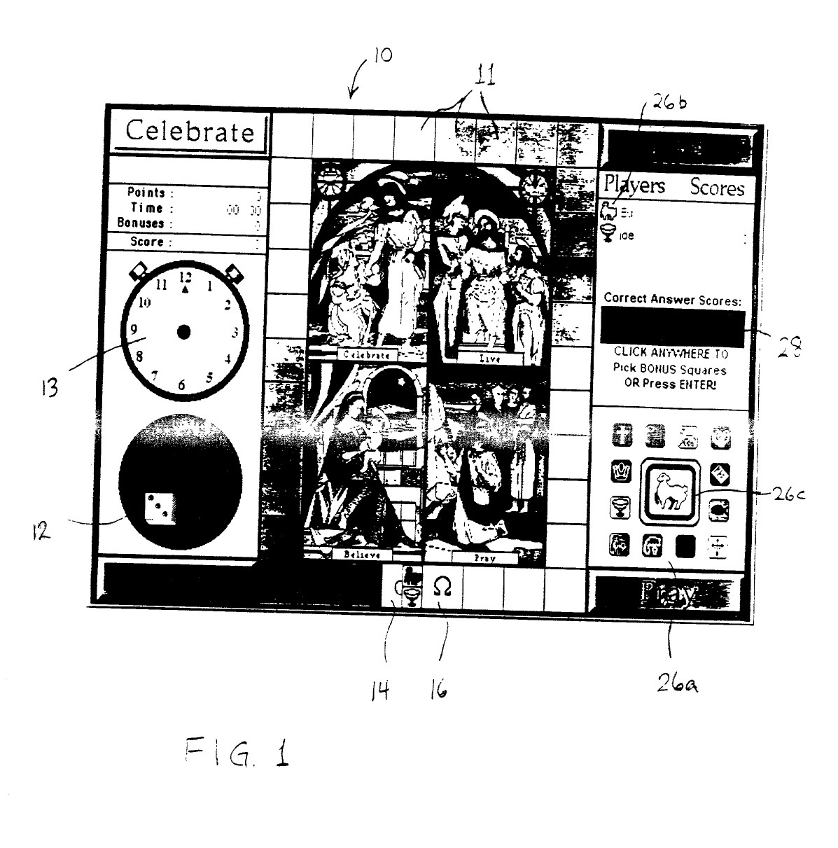

FIG. 1 shows a sample virtual board 10 for use in a preferred embodiment of the present invention. The board is displayed on the computer monitor or other display device and preferably includes a plurality of spaces 11 constituting a clockwise path between a start 14 and a finish square 16. In a preferred embodiment the player proceeds through the path by rolling a viral die 12, in order to move his or her game piece the number of spaces indicated by the die 12, and by correctly answering at least one randomly selected question (from a pool of stored questions) that the game poses after the player's game piece moves to the new space. If the player answers the question(s) correctly, then he or she is allowed to stay on the new space and is given points. If the question is not answered correctly, then the player is moved back to the space 11 that it occupied before the die 12 was rolled. The winner of the game is determined based on the mode that the players select, as described-in more detail below.

The illustrated path in FIG. 1 has 32 spaces between the start 14 and finish square 16, meaning that the player must move a total of 33 spaces to pass the finish line. Although any number and/or shape of spaces 11 can be used in the present invention, it is preferable for the path to be broken down into different regions which correspond to different categories from which the game selects the questions. For example, the game may test the players' knowledge of religion, and can have eight spaces delegated to each of four religious topics, Believing, Celebrating, Living and Praying.

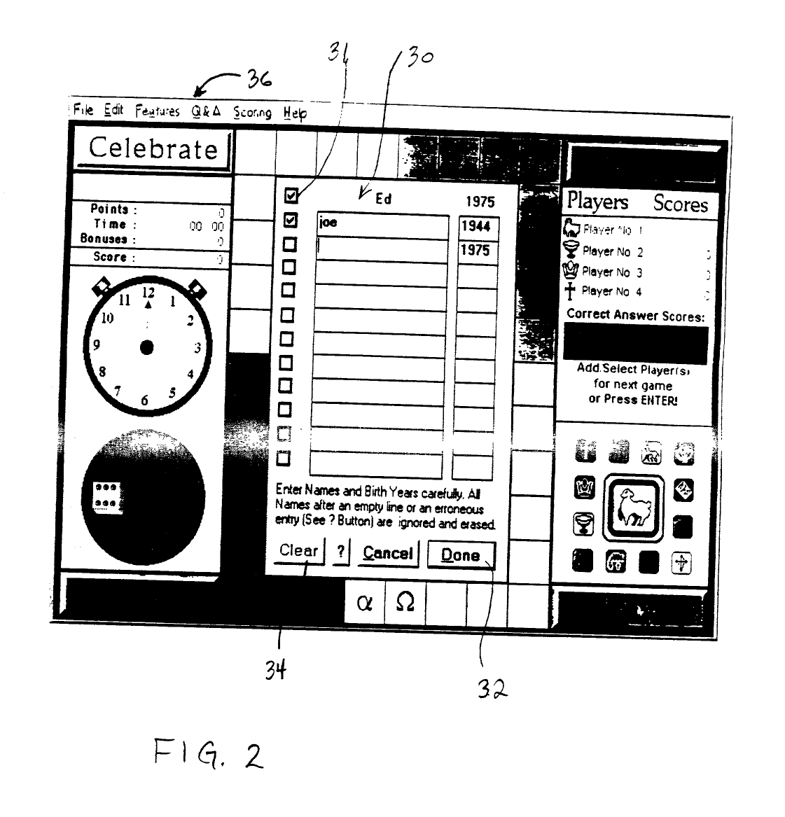

At start-up, the game asks for the names and optionally the birth years or birth dates of the players. A blank list such as the Player List 30 shown in FIG. 2 is displayed and the players use the computer's keyboard and/or mouse to enter their names into the fields of the list. The names are recorded into a Player's List that is held in the computer's working memory and will be accessed during and after the game. The game can accommodate one or more players. Their names and birth dates (or birth years) can be stored in memory even when the game is dormant and not being played. When games are saved, the stored Player List can be made to contain the names of the players of the saved game rather than the game's complete Player List. Once the Players have entered some players' names and birth years, they can select who will play the next game by clicking on the check box 31 in front of their Names.

The registered owner of the game will be asked to input his or her name when the game is installed and played for the first time. Thereafter, the owner will be presumed to be one of the players of any particular game, with an option not to include him or her in the current game. In FIG. 2, Ed is the registered owner. The most recently entered names will be kept in memory, and when a new game is to be played, the game will offer the list of those names so that the players can select themselves, thereby avoiding the need to enter their names and birth dates all over again. If more than one game is played during a session, the players are carried over for the ensuing games unless they are de-selected by removing the check mark from check box 31, which can be done with a mouse-click, perhaps leaving the winner to play a new set of players. The TAB key on the computer's keyboard is preferably used to navigate through the Player List 30 from box to box. Arrow keys can also be used within a box. When the Player List is complete, the “Done” button 32 can be clicked on with a mouse, or tie <Enter > or <Return > key or Alt-D or Command-D can be used to activate the Done button 32. The graphic of FIG. 2 includes a “Clear” button 34 which erases all names and years after a warning dialog is displayed. Activating the Done button 32 triggers the game to begin.

The sequence in which the players play the game is selected randomly by the game. Alternatively, the sequence can correspond to the sequence in which their names were entered into the game, or the players can designate a desired sequence. During random selection, the game preferably simulates a die roll for each player, with the player with the highest roll going first, and second highest second, and so on. The random selection of the sequence is done as soon as the players indicate that they are “Done” 32 entering their names.

The players can select to have zero, one, or more mystery bonus squares on the path by pulling down a Scoring menu from the menu bar 36. The location of these squares along the path is randomly chosen by the game and hidden from the players. When a player lands on any one of these squares a series of dialog boxes are displayed in order to tell the player what is happening and what to do. If the players select to have bonus squares after the game has begun, then the game chooses the squares out of the squares that lie in front of the players, so the players know that more mystery bonus squares lie ahead. Mystery bonus squares offer bonus points that are accumulated, but can be lost under the proper circumstances. Selecting the mystery bonus squares is done by running a random-number generator within the number of squares 11 that can still be landed on.

The game randomly selects a predetermined number of squares of the path to be the mystery squares. The player who lands on the square is offered a question just like a normal square, but if the question is answered correctly, then the player is given the option to continue or stop. If they continue with bonus questions, then one-by-one the player is offered another question up to a predetermined number. After each correctly answered question, the player has the option of continuing. If the player elects to stop or has reached the maximum number of questions and answered all of them correctly, then he or she is given the number of points accumulated during that round. If the player answers a question incorrectly at any time during the round, then the round is automatically ended and the player is given no points. Thus the mystery square presents a risk to the players, making them decide whether they are confident enough to accumulate many points or to settle for what they have already earned.

Whenever a player lands on a mystery bonus square, he or she is so informed by a dedicated graphic and is then posed a question. If the question is answered correctly, the player is awarded normal points and is offered the choice of being posed a second question or settling for the bonus points awarded by the first question. In alternative scoring methods, the player who answers a question correctly can be awarded normal points plus bonus points, or only bonus points.

A player who has fallen behind in points can have a double motive for wanting a new set of mystery bonus squares, one—a chance to land on them and score points, and two—to make it possible for the opponents to have the same opportunity, which puts at risk the points the opponent has already scored. The mystery bonus square preferably offers an opportunity to name a hymn or other audible test.

When all but one of the players have reached the finish square 16, the last player can move into the finish square 16 if the number rolled on the die 12 meets or exceeds what is necessary to reach the finish line from the player's current square. However, in order to maximize the chance of the last person landing on a mystery bonus square, when any one of the squares lying between the current square and the finish line square is a mystery bonus square, the game preferably only allows the player to reach the finish line square if the die 12 shows the exact number needed. This increases the number of rolls the last player takes, and thus increases the chance that the player will land on the mystery bonus square.

When played on a personal computer or computer network, the game itself is preferably recorded on a compact disk or other portable medium readable by the computer. When played in a dedicated game device or computer network, the game is preferably recorded in an internal memory, such as a hard drive or memory chip. The artisan, however, will recognize that the present invention can take many forms. Displaying and running computer games on a personal computer are known in the art and therefore need not be further detailed herein.

The game of the present invention is preferably recorded on a portable medium that can be sold to consumers, such as a read-only CD, a rewritable CD or diskette, or a programmable chip. The game can also be embodied in an electronic signal stored at one location and transmitted over wired or wireless communication lines to another location or multiple locations. For example, the game can be downloaded and/or played over the Internet. In preferred embodiments, the game is embodied on a CD ROM in a Macintosh version or a Windows version. The game can be implemented and designed using basic tools. For example, the Macintosh version can be designed in Apple's HyperCard 2.3 which allows development of graphics. A compiled application can be accomplished using the Future Basic II Compiler/Programming Environment. Graphics are cut and pasteable into ResEdit, an Apple Computer Resource Editor. Styled text and graphics can be created and/or modified in Claris Works and then cut/pasted into ResEdit. The questions and answers which are used by the game can be entered directly into ResEdit with its built-in string editor. Styled text could be handled in the same manner, but ResEdit, although recognizing color in style text, does not allow direct color entry through its own editor except as cut/copy/paste items. Since Future Basic II is a highly developed extension of older basic languages but provides full access to almost all of the Macintosh Quickdraw ROM routines, and Visual Basic was originally created as Microsoft's answer to Apple's HyperCard but with a Miscrosoft Basic inheritance, a Windows95 version of the present invention is possible using Visual Basic 5.0. The programming for the Windows95 version can be done on a 225 MHZ Power Macintosh running the Mac Operating System, with Visual Basic 5.0 running in Windows 95 under Insignia's SoftWindows. This allows one to copy and paste from the ResEdit Pict files of the Mac version into the Paint application in the Windows environment, making transformation of graphics fairly easy. Sound and music can be handled in a similar manner using Macromedia's Sound Edit 16 to transform Mac Sound Resources into Windows WAVE files. Music can be recorded onto standard tape cassettes and moved to the Sound Edit 16 Program directly from the cassette player via the Mac's built-in sound microphone. There the music can be edited for use by both Mac Resources and Window's WAVE files. Almost all of the Windows programming can be done using pure Visual Basic, although a few API routines can be brought into play for some situations. The present invention is clearly not limited to these or any other programming tools since, as the artisan will recognized, there are innumerable other ways to carry out the game of the present invention.

Most of the game's features or options described herein are preferably accessible through a pull-down menu 36 (FIG. 2) when the game is played in a Windows environment. Such menus are known in the art and need not be further explained. The game is loaded from the medium onto the computer's hard drive and played from there in concert with the CD ROM in the computer's CD reader. In a Windows environment, a particular game can be saved to a Folder at some convenient location on the hard drive. Some of the options may include whether the correct answers are going to be shown after the player answers a question, whether the authorities for each answer are going to be displayed along with the question, whether the questions are audibly posed by the computer's sound card, or whether the games should be limited to questions having a particular level of difficulty. The maximum number of points that may be scored for each question is based on the assigned level of difficulty for the question. The difficulty level can also be randomly chosen by the game at each turn. Other options include the maximum amount of time that the game will wait for a player to input an answer to the current question. During the player's turn, in addition to having the clock 13 visibly ticking away, the points to be scored are displayed in area 28 and continually diminish by 1, 2 or whatever interval of points is used, e.g., depending on the level of difficulty for the question.

Playing The Game:

Each game starts with all players on the first square 14. The first player moves his or her game piece by pressing either the <enter > or <return > keys on the computer keyboard, or by clicking the mouse anywhere on the screen, causing the game automatically to simulate the rolling of die 12. Die 12 serves as a distance determining device, and if it is a simulated six-sided die then the player moves between 1 and 6 squares each turn. The artisan will recognize that other keyboard, menu, or dedicated switches can be used to “roll” a die or to otherwise decide how far to move the player's game piece. For example, a dedicated “die area” on the display can be where the player is to click the mouse, or a simulated needle can spin to a certain number, or a randomly generated number can be used. The game automatically “moves” the player's game piece by erasing the game piece from its previous square 11 and having it reappear on a new square.

In the preferred embodiment, the player is then presented with a randomly selected question displayed on the screen. At the same time, a timer is started and can but need not be displayed, such as at 13. The question appears in the form of a multiple choice question with two or more choices to select as the answer, preferably only one of which is correct. In a preferred embodiment, the question is related to religion. If the player selects the correct answer, then he or she is allowed to stay on the new square and is awarded points based on the difficulty of the question, the speed in which the question was answered, or a combination of the two. If the question is answered incorrectly, then the player returns to the old square, and optionally can be awarded negative points. In an alternative embodiment, the player who answers the question incorrectly can be allowed to stay on the new square and be penalized in some other fashion, such as by awarding negative points.

The appearance of each player's game piece is automatically selected, or if the players so choose they can select their pieces from a pool of pieces that are available in the game. The available pieces are shown at region 26a of FIG. 1. In the upper right comer of the board 10, a small line image 26b of each player's game piece appears in front of the players' names. The player who is currently taking his or her turn has their name and game piece displayed in bold or color, such as red, so that everyone knows whose turn it is. A colored arrow can also be displayed next to the current player's name.

A scoring box 28 on board 10 shows the number of points available for the question. If points are awarded based on speed in answering, then the number of points slowly decreases as the game waits for the player to select an answer. In region 26c below the scoring box 28 a large color version of the current player's game piece also serves to notify which player is the current player. Optionally, a voice simulator can announce the current player's name. The clock 13 can appear as any type of timer, such as a simulated hourglass, a digital clock, etc.

Several modes of play are contemplated: Points Only, Time Only, and Points and Time, any of which may be played in a Contest mode. A particular implementation of the present invention can offer the players any one or more of these modes. Other modes can also be created and offered, and each mode can further have different variations. For example, each mode can be varied by choosing to subtract the point and/or time scores for wrong answers from those scored for correct answers. The winner can be the player with the highest score, in which case the game is over when the last player reaches the finish line 16 and scores are compared. The game can also be a race to the finish line 16. Regardless of the variation, the game preferably stores a list of players' scores in memory, such as in the working memory of the personal computer.

Points Only Games:

The game maybe played as a very simple game with all players being posed questions of the same level of difficulty and scoring the same number of points when they answer the question correctly. Different levels of difficulty still offer more or fewer points, but the player need not worry about the amount of time he or she takes to input the correct answer. This mode preferably has a response time limit so that the game will not wait infinitely long for the player to input his or her answer.

In a variation of this mode, players can receive a different number of points depending on their age, as based on the birth years input into the players list 30. Time, however, is not a factor.

In the Points Only mode, the game ends when the first player reaches the finish line square and answers his or her final question correctly. Preferably, the last question is an incomplete quotation which the player must complete correctly using one of the multiple-choice endings. In a “race” version of this mode, the first player to land on the finish line square and answer the final question correctly is the winner regardless whether other players have more points at that time. A “most points” variation would be to await all players at the finish line and make the player with the most points be the winner. In the event of a tie in points, the winner becomes the player who took the lowest aggregate amount of time to answer his or her questions.

The Points Only mode can also be modified either to award no points for incorrect answers, or to subtract points for wrong answers. Whenever a player answers a question incorrectly, for example, the number of points that might have been scored for a correct answer are subtracted from that player's total score in addition to returning the player's game piece to its previous space.

Time Only Games:

This mode uses only time to measure how well a player has done. All players must reach the finish line square before the winner is determined. The winner is the player who has the least amount of aggregate time (e.g., minutes and seconds) posted to their scores. The first player to reach the finish line square can be awarded bonus points, as can the winner of any other mode, e.g., a subtraction of 30 seconds from their aggregate time. During each player's turn, the clock 13 and/or score box 28 begin at zero and tick up to a predetermined maximum time-out. Alternatively, the clock 13 and/or score box 28 can show an initial amount of time allotted for the question and the time keeps ticking down, in which case the goal would be to have the highest score.

An “actual time” version can add the actual elapsed time to a player's total time regardless whether they answer a question correctly. Of course, a missed question causes their game piece to return to its previous square.

If mystery bonus squares are used with the Time Only mode, then bonus points for answering correctly the bonus second, third, etc., questions are useless because it is a time only game. Therefore, the bonus points are preferably negative time. For example, at the end of the game the bonus points are converted to “minus seconds” at the rate of 1 second for each 10 points. Also, the bonus can be that the player's game piece is not returned to its previous square regardless of whether they answer the extra question correctly.

Point & Time Games:

This mode is similar to the Points Only mode except that the points awarded for correct answers are reduced, depending on the level of difficulty of the question, by 1, 2, 3, or some other number of points for each second it takes for the player to answer the question. The points tick down along with the clock, both of which are preferably displayed during each player's turn at the right side of the virtual board. In one variation, points can be awarded for correct answers, and no points deducted for incorrect answers. In another variation, points can be awarded for correct answers and subtracted for incorrect answers (the number of points subtracted can be the same or different from the number that would have been added had a correct answer been selected).

Contest mode:

The Contest mode can be implemented in a particular game, or as a locally and/or nationally organized competition. For religious versions of the game, a church can sponsor the contest to test students' religious instruction. The Contest is an opportunity for individuals to play the game and compete for prizes and recognition.

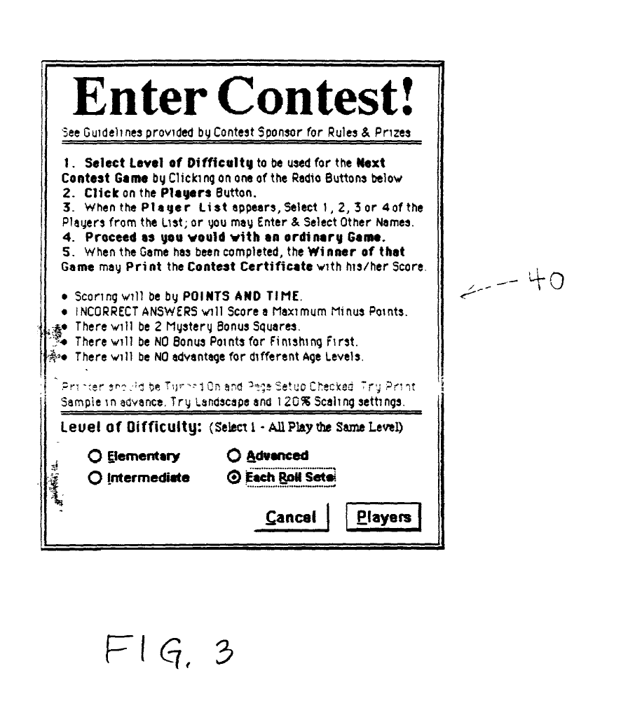

The Contest mode can be selected in a variety of manners, such as selecting the mode from a pull-down File menu, entering a designated set of keystrokes, clicking the mouse in a particular region of the display, or by any other means. An “Enter Contest!” dialog box then appears, such as the dialog box 40 shown in FIG. 3. A level of difficulty can be selected by the players, followed by a selection of who the players of the game will be from the players list 30. The players are selected in the same manner that players are selected for other modes of the present invention. The “Done” button is then activated. The players selected will then be randomly ordered and two mystery bonus squares (or any other predetermined number) are picked by the game. The game is played as would a regular game. In an optional variation, the players may quit in the middle of a Contest game to start a new one (e.g., they got off to a really bad start).

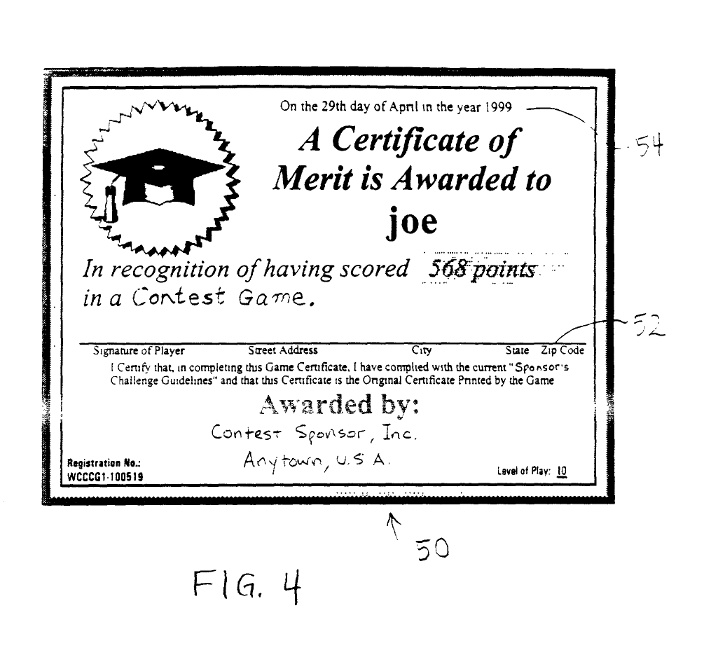

When all players have finished the game in the Contest mode, the player with the highest score will be printed a Contest Certificate such as certificate 50 in FIG. 4. It contains a line 52 where the player signs his or her name and enters information about where they live. The players then submit the certificate with the very highest score to the Contest Sponsor as instructed by that sponsor.

In non-Contest modes of play, a certificate can be generated for every player who, at the end of a game, reached a predetermined number of points or a predetermined minimum time. It may be printed on the spot by clicking a Print button (not shown) from the menu bar 36 or it may be printed automatically when the game is exited. Such options are preferably offered through pull down menus from the menu bar 36, as is well known to those skilled in Windows-type programming. However, it is preferable that such non-Contest certificates differ in appearance from official Contest certificates.

The certificate 50 is printed by generating a data packet and transmitting it to the printer. For games played on a personal computer, the data packet is preferably output through the computer's printer port. The data constituting the data packet should include a prestored graphic forming the basic appearance of the certificate. Any desired graphic can be used. In embodiments played on computer intranet or internet networks, data specific to that particular Contest is transmitted from a central location, such as from the sponsor, and stored locally in the player's computer for use in generating the certificate. Such data preferably includes a Contest identifier and a graphic forming the basic appearance of the certificate.

The game is executed as a set of software instructions. As such, the game includes instructions to be executed by the controller, which can be the computer's microprocessor. At the end of a Contest game, the controller is instructed to extract information specific to the winner of the game and deposit the information into a data packet useable by a printer. This information is extracted from the stored list of players' names and the accumulated score list. The information also includes one or more pieces of data specific to that Contest if such data was transmitted by the sponsor or other remote source. The date on which the game was played should be gathered from the computer's internal calendar and printed 54 onto the certificate 50. The extracted information is then formatted together with the basic certificate graphic into a printer data packet. Preferably, the winner is presented an option whether to print the certificate immediately or to wait until the current game is completed. In the latter case, the controller is instructed to save the printer data packet until the next game has commenced or until an “exit game” command is received. If the player(s) elect to have the data saved until the next game is started, then in the interim period before the next game, an option may be presented to print the certificate immediately. The format and contents of such packets are known to those skilled in the art and need not be further detailed herein. The packet is transmitted to a remote printer, or an integrated printer if present, so that the certificate is printed. The sponsor can supply special paper to the contestants in order to further enhance the authenticity of the certificate.

In Contest modes sponsored by an organization, the rules should stipulate that all winners' certificates be submitted to the sponsor, and an ultimate winner(s) is determined based upon the information borne by the certificates. Because one certificate is submitted to the sponsor, the game can be configured to generate two certificates, preferably separately identifiable based on some indicia printed on the certificate, such as “winner's copy” and “sponsor's copy.” In this way, the winner gets to keep a certificate for posterity.

The game is intended to be played by people of all ages. In order to make point-scoring more equal for players of different ages, the number of points or amount of time awarded to a player is weighted according to the player's age. A plurality of weighting scales is offered to the players so that the difference in scores between older and younger players can be made more or less drastic. The age is part of the stored player's list, thereby allowing the controller to vary the awarded points or time for each player. For example, a player age 6 and younger receives more points for answering the same question than a player age 20 and over. During a Contest mode, the data packet preferably includes the birth date or age of the player. The level of difficulty can be printed on the certificate, and can be tied to the player's age or selected by the player.

The invention having been thus described, it will be obvious that the same may be varied in many ways, not only in construction but also in application. Such variations are not to be regarded as a departure from the spirit and scope of the invention, but rather as modifications intended to be encompassed within the scope of the following claims.

What is claimed is:

1. An electronic game having at least one mode of play, the one mode comprising:
inputting names of at least one player of the game;
posing at least one of a plurality of questions to each player of the game during the player's respective turn;
inputting, by the player, an answer to a posed question;
accumulating a score for each player based upon whether answers to the questions are correct;
selecting a winner based upon each player's score at the end of the game; and
generating a certificate data packet, the data packet being a set of instructions for use by a printer to print a certificate, the data packet including the name of the winner.

2. The game of claim 1, wherein the score is further accumulated based upon incorrect answers input by the player.

3. The game of claim 1, wherein the game has a printing device and the data packet further includes the score of the winner, said mode of play further comprising:
printing the name and score of the winner onto the certificate based upon the certificate data packet.

4. The game of claim 3, wherein the one mode is played a plurality of times, and said game further comprises:
collecting a plurality of the certificates from a plurality of winners; and
determining an ultimate winner based upon scores borne by the collected certificates.

5. A recording medium bearing a computer-executable game, the game having at least one mode of play, the mode comprising:
inputting names of at least one player of the game;
posing at least one of a plurality of questions to each player of the game during the player's respective turn;
inputting, by the player, an answer to a posed question;
accumulating a score for each player based upon whether answers to the questions are correct;
selecting a winner based upon each player's score at the end of the game; and
generating a certificate data packet, the data packet being a set of instructions for use by a printer to print a certificate, the data packet including the name of the winner.

6. The game of claim 5, wherein the score is further accumulated based upon incorrect answers input by the player.

7. The game of claim 5, wherein the game has a printing device and the data packet further includes the score of the winner, said mode of play further comprising:
printing the name and score of the winner onto the certificate based upon the certificate data packet.

8. The game of claim 7, wherein the one mode is played a plurality of times, and said game further comprises:
collecting a plurality of the certificates from a plurality of winners; and:
determining an ultimate winner based upon scores borne by the collected certificates.

9. An electronic signal constituting a game, the game having at least one mode of play, the one mode comprising:
inputting names of at least one player of the game;
posing at least one of a plurality of questions to each player of the game during the player's respective turn;
inputting, by the player, an answer to a posed question;
accumulating a score for each player based upon whether answers to the questions are correct;
selecting a winner based upon each player's score at the end of the game; and
generating a certificate data packet, the data packet being a set of instructions for use by a printer to print a certificate, the data packet including the name of the winner.

10. The game of claim 9, wherein the score is further accumulated based upon incorrect answers input by the player.

11. The game of claim 9, wherein the game has a printing device and the data packet further includes the score of the winner, said mode of play further comprising:
printing the name and score of the winner onto the certificate based upon the certificate data packet.

12. The game of claim 11, wherein the one mode is played a plurality of times, and said game further comprises:
collecting a plurality of the certificates from a plurality of winners; and:
determining an ultimate winner based upon scores borne by the collected certificates.

13. A method of holding a contest, comprising:
playing a game a plurality of times;
for each of the plurality of times the game is played, printing a name of at least one player who played the game onto a certificate;
collecting the certificates; and
selecting one of the collected certificates to determine a winner of the contest.

14. The method of claim 13, wherein the game is a computer-executable game having at least one mode of play, the mode comprising:
inputting names of at least one player of the game;
posing at least one of a plurality of questions to each player of the game during the player's respective turn;
inputting, by the player, an answer to a posed question;
accumulating a score for each player based upon whether answers to the questions are correct;
selecting a winner of the game based upon each player's score at the end of the game; and
generating a certificate data packet, the data packet being a set of instructions for use by a printer to print a certificate, the data packet including the name of the winner of the game.

15. The method of claim 13, wherein said printing step includes:
printing the name and score of the winner of the game onto the certificate based upon the certificate data packet. 16. The method of claim 15, wherein said selecting step includes selecting the winner of the contest based upon the scores borne by the collected certificates.
